(19) United States
(12) Patent Application Publication
(10) Pub. No.: US 2016/0261505 A1
(43) Pub. Date: Sep. 8, 2016

(54) LOCALIZED SERVICE CHAINING IN NFV CLOUDS

(71) Applicant: ALCATEL-LUCENT USA, INC., Murray Hill, NJ (US)

(72) Inventors: Iraj Saniee, New Providence, NJ (US); Mark Clougherty, Chatam, NJ (US); Harish Viswanathan, Morristown, NJ (US)

(73) Assignee: Alcatel-Lucent USA, Inc.

(21) Appl. No.: 14/638,592

(22) Filed: Mar. 4, 2015

(51) Int. Cl. H04L 12/803; H04L 12/721; H04L 29/08

(52) U.S. Cl. CPC H04L 47/125; H04L 67/10; H04L 45/26

(57) ABSTRACT

Various exemplary embodiments relate to a chaining of sequential functions associated with a service or application are considered. This approach relies on a centralized load balancer for reducing the load of inter-rack traffic in a data center. The centralized load balancer may include a memory configured to store a service data flow table; and a processor configured to: receive at the centralized load balancer, a path inquiry for a service data flow; determine which virtual machine to assign the service data flow, wherein at least two functions of a chain of functions required in the service data flow are to be performed on the same rack; and assign the service data flow to the determined virtual machine.

### TECHNICAL FIELD

Various exemplary embodiments disclosed herein relate generally to computer networking, and more particularly to cloud computing or use of data centers.

### BACKGROUND

As cloud computing becomes more prevalent, enterprises and other entities are seeking to migrate varying types of applications into cloud data centers. Network Function Virtualization (NFV) has helped enable this migration of services into data centers. Some examples of virtual functions that may be run in a telecommunication service provider data center include Content Delivery, Evolved Packet Core (EPC), Customer Premises Equipment (CPE) and Radio Access. Applications or services frequently involve such a sequence of functions that are performed on the packets constituting the specific instance of the application or service. In cloud applications, each application or service frequently requires multiple virtual functions to run sequentially on a multiplicity of virtual machines. The sequence of such functions in a service chain may be stamped on the header of each packet belonging to the service chain for subsequent processing. The selection of which virtualized resources are to be used for the processing of each function for an instance of a packet flow belonging to a service is the topic of interest in the embodiments described below.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of balancing a load of inter-rack traffic in a data center including a plurality of racks. The method including receiving at a centralized load balancer, a path inquiry including a chain of functions for a service data flow; determining which virtual machine will perform each function of the chain of functions for the service data flow, wherein at least two functions of the chain of functions required in the service data flow are to be performed on the same rack; and assigning the service data flow to the determined virtual machines.

Various exemplary embodiments are described wherein the determining further includes: utilizing policy information to determine which virtual machines will process the service data flow.

Various exemplary embodiments are described wherein the determining further includes: utilizing current virtual machine capability information to determine which virtual machines will process the service data flow.

Various exemplary embodiments are described wherein identical load balancers are instantiated on two or more racks in the data center.

Various exemplary embodiments are described wherein the determining further includes: utilizing a round robin assignment algorithm to determine which virtual machines will process each instance of a virtual function of a service data flow.

Various exemplary embodiments are described further comprising: updating which virtual machine will perform at least one of the functions of the chain of functions.

Various exemplary embodiments are described including a non-transitory machine-readable storage medium encoded with instructions for execution by a centralized load balancer for balancing a load of inter-rack traffic in a data center including a plurality of racks, the medium including instructions for receiving at the centralized load balancer, a path inquiry including a chain of functions for a service data flow; instructions for determining which virtual machine will perform each function of the chain of functions for the service data flow, wherein at least two functions of the chain of functions required in the service data flow are to be performed on the same rack; and instructions for assigning the service data flow to the determined virtual machines.

Various exemplary embodiments are described, wherein the determining further includes: utilizing policy information to determine which virtual machines will process the service data flow.

Various exemplary embodiments are described wherein the determining further includes: utilizing current virtual machine capability information to determine which virtual machines will process the service data flow.

Various exemplary embodiments are described wherein identical load balancers are instantiated on two or more racks in the data center.

Various exemplary embodiments are described wherein the determining further includes: utilizing a round robin assignment algorithm to determine which virtual machines will process each instance of a virtual function of a service data flow.

Various exemplary embodiments are described, further comprising: updating which virtual machine will perform at least one of the functions of the chain of functions.

Various exemplary embodiments are described including a centralized load balancer for balancing a load of inter-rack traffic in a data center including a plurality of racks. The centralized load balancer including a memory configured to store a service data flow table; a processor configured to: receive at the centralized load balancer, a path inquiry including a chain of functions for a service data flow; determine which virtual machine will perform each function of the chain of functions for the service data flow, wherein at least two functions of the chain of functions required in the service data flow are to be performed on the same rack; and assign the service data flow to the determined virtual machines.

Various exemplary embodiments are described wherein the centralized load balancer is further configured to: utilize policy information to determine which virtual machines will process the service data flow.

Various exemplary embodiments are described wherein the centralized load balancer further is further configured to: utilize current virtual machine capability information to determine which virtual machine to provide the service data flow to.

Various exemplary embodiments are described wherein an identical centralized load balancer is instantiated on two racks in the data center.

Various exemplary embodiments are described wherein the centralized load balancer is further configured to: utilize a round robin assignment algorithm to determine which virtual machines will process the service data flow.

Various exemplary embodiments are described wherein the centralized load balancer is further configured to: update which virtual machine will perform at least one of the functions of the chain of functions.

### BRIEF DESCRIPTION OF THE DRAWINGS

In order to better understand various exemplary embodiments, reference is made to the accompanying drawings, wherein:

FIG. 1 illustrates an exemplary cloud environment;

FIG. 2 illustrates a hardware diagram of an exemplary host device;

FIG. 3 illustrates an exemplary generalized rack configuration;

FIG. 4 illustrates an exemplary data center involving localized service chaining which utilizes a centralized load balancer configuration;

FIG. 5 illustrates an exemplary method for a centralized load balancer initialization process; and

FIG. 6 illustrates an exemplary method for centralized load balancing.

To facilitate understanding, identical reference numerals have been used to designate elements having substantially the same or similar structure or substantially the same or similar function.

### DETAILED DESCRIPTION

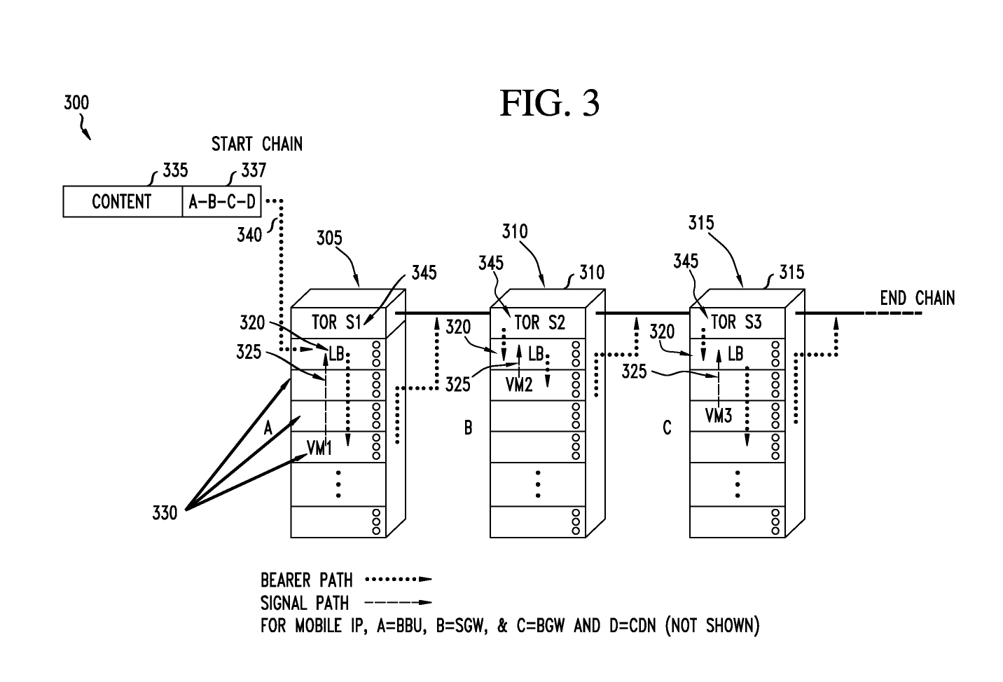

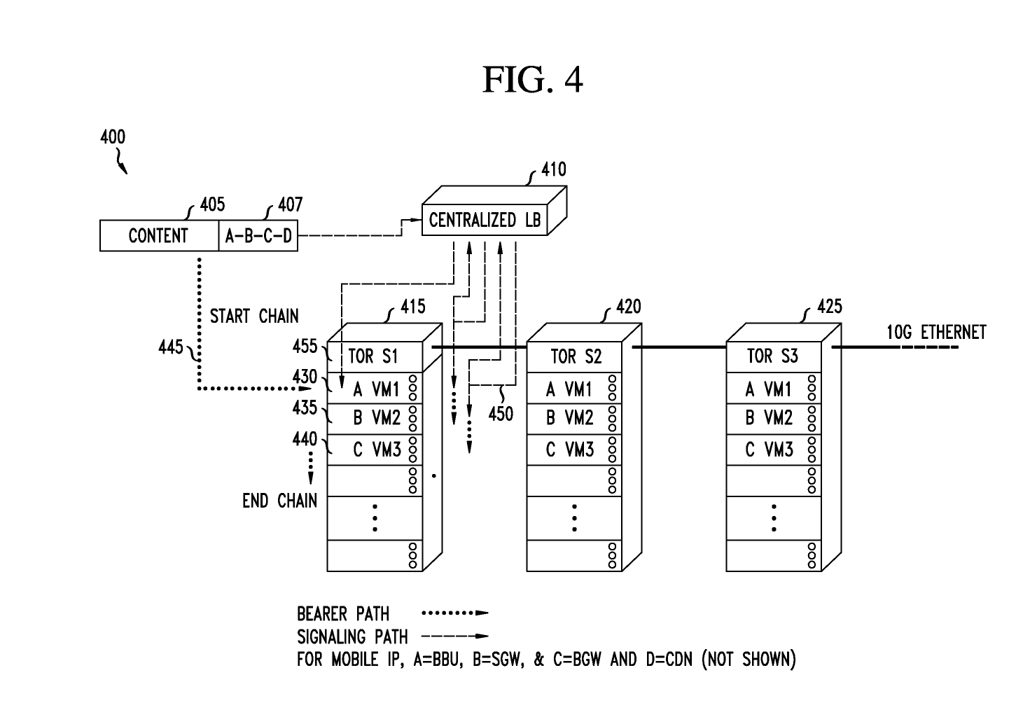

Large volumes of inter-rack communication frequently cause latencies and delays in processing in data centers. For example, the configuration shown in FIG. 3 results in a higher percentage of the traffic to traverse the links connecting the racks which constitute the chains of service. In contrast, the proposed configuration in FIG. 4 results in (much) less inter-rack traffic. The higher the volume of traffic, the larger the latency to communicate or pass packets between racks takes compared to communication within a single rack. Accordingly, there exists a demand for faster processing within data centers and higher utilization of individual racks.

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

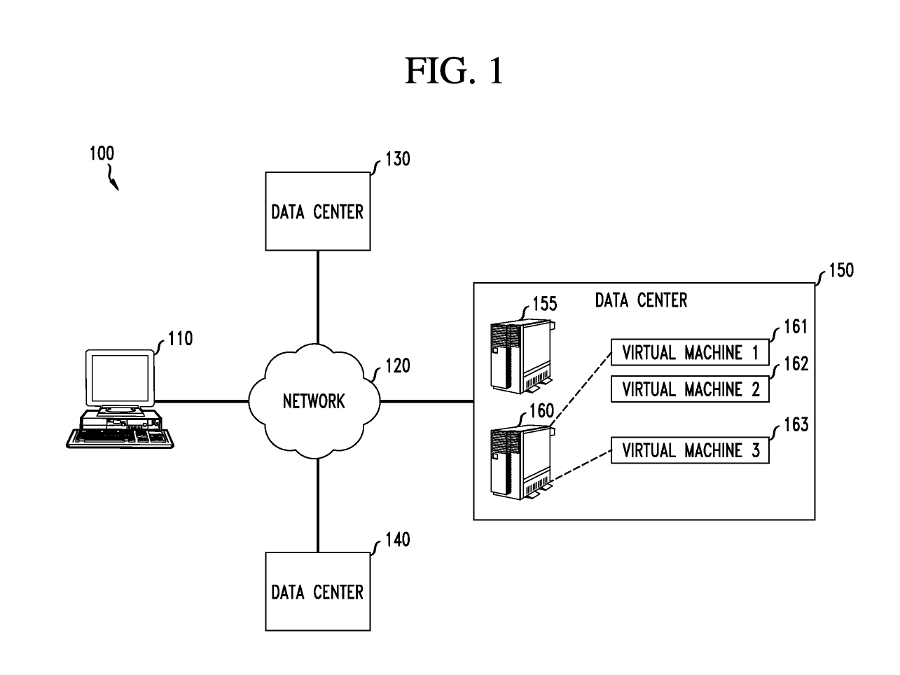

FIG. 1 illustrates an exemplary cloud environment 100. As shown, the cloud environment 100 includes a user device 110 connected to a network 120. The user device 110 may be any device operable by a user to communicate via a network. For example, the user device 110 may be a desktop computer, laptop, tablet, mobile phone, set top box, or video game console. Further, the network 120 may be any network capable of facilitating inter-device communication. In various embodiments, the network 120 includes an IP/Ethernet network and may include the Internet.

The cloud environment also includes multiple data centers 130, 140, 150. It will be apparent that fewer or additional data centers may exist within the cloud environment. The data centers 130, 140, 150 each include collections of hardware that may be dynamically allocated to supporting various cloud applications. In various embodiments, the data centers 130, 140, 150 may be geographically distributed; for example, data centers 130, 140, 150 may be located in Washington, D.C.; Seattle, Wash.; and Tokyo, Japan, respectively.

Each data center 130, 140, 150 includes host devices for supporting virtualized devices, such as virtual machines. For example, data center 150 is shown to include two host devices 155, 160, which may both include various hardware resources. It will be apparent that the data center 150 may include fewer or additional host devices and that the host devices may be connected to the network 120 and each other via one or more networking devices such as routers and switches. In various embodiments, the host devices 155, 160 may be personal computers, servers, blades, or any other device capable of contributing hardware resources to a cloud environment. Similarly, host devices 155, 160 may be put on a rack or multiple racks with one or more similar devices.

The various host devices 155, 160 may support one or more cloud-based applications. For example, host device 160 is shown to support multiple virtual machines, (VM) VM 1 161, VM 2 162, and VM 3 163. As will be understood, a VM is an instance of an operating system and software running on hardware provided by a host device imitating dedicated resources as in a single machine. Various alternative or additional network functions will be apparent such as, for example, load balancers, and HTTPS. Such functionality may be provided as separate VMs or, as illustrated, in another type of virtualized device termed a “container.” As will be understood, a container is similar to a VM in that it provides virtualized functionality but, unlike a VM, does not include a separate OS instance and, instead, uses the OS or kernel of the underlying host system.

While the virtualized devices 161-163 are described as being co-resident on a single host device 160, it will be apparent that various additional configurations are possible. For example, one or more of the virtualized devices 161-163 may be hosted among one or more additional host devices 155 and/or racks within a data center, or among one or more additional data centers 130-150.

It will be apparent that while the exemplary cloud environment 100 is described in terms of a user device accessing a web application, the methods described herein may be applied to various alternative environments. For example, alternative environments may provide software as a service to a user tablet device or may provide backend processing to a non-end user server. Various alternative environments will be apparent.

According to various embodiments, the host device 160 implements a virtualized switch for directing messages received by the host device 160 to appropriate virtualized devices 161-163 or other devices or virtualized devices hosted on other host devices or in different data centers. As will be described in greater detail below, in some such embodiments, the virtualized switch is provided with instructions, such as code or configuration information, for forwarding traffic through a sequence of network function devices before being forwarded to the application VM. As such, the switch may forward traffic to locally hosted virtualized devices or to external devices or virtualized devices as well as a local or other types of load balancers.

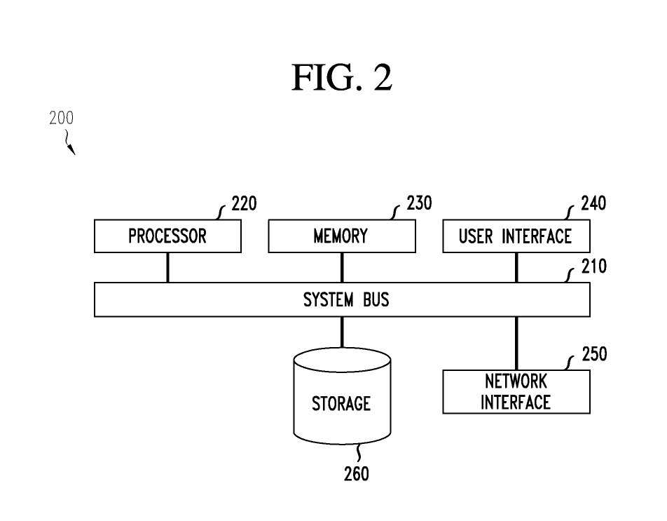

FIG. 2 illustrates a hardware diagram of an exemplary host device 200. The exemplary host device 200 may correspond to one or more of the host devices, including host devices 155, 160, of the exemplary cloud environment. As shown, the host device 200 includes a processor 220, memory 230, user interface 240, network interface 250, and software storage 260 interconnected via one or more system buses 210. It will be understood that FIG. 2 constitutes, in some respects, an abstraction and that the actual organization of the components of the host device 200 may be more complex than illustrated.

The processor 220 may be any hardware device capable of executing instructions stored in memory 230 or software storage 260 or otherwise processing data. As such, the processor may include a microprocessor, field programmable gate array (FPGA), application-specific integrated circuit (ASIC), or other similar devices.

The memory 230 may include various memories such as, for example L1, L2, or L3 cache or system memory. As such, the memory 230 may include static random access memory (SRAM), dynamic RAM (DRAM), flash memory, read only memory (ROM), or other similar memory devices.

The user interface 240 may include one or more devices for enabling communication with a user such as an administrator. For example, the user interface 240 may include a display, a mouse, and a keyboard for receiving user commands. In some embodiments, the user interface 240 may include a command line interface or graphical user interface that may be presented to a remote terminal via the network interface 250.

The network interface 250 may include one or more devices for enabling communication with other hardware devices. For example, the network interface 250 may include a network interface card (NIC) configured to communicate according to the Ethernet protocol. Additionally, the network interface 250 may implement a TCP/IP stack for communication according to the TCP/IP protocols. Various alternative or additional hardware or configurations for the network interface 250 will be apparent.

The software storage 260 may include one or more machine-readable storage media such as read-only memory (ROM), random-access memory (RAM), magnetic disk storage media, optical storage media, flash-memory devices, or similar storage media. In various embodiments, the software storage 260 may store instructions for execution by the processor 220 or data upon which the processor 220 may operate.

While the host device 200 is shown as including one of each described component, the various components may be duplicated in various embodiments. For example, the processor 220 may include multiple microprocessors that are configured to independently execute the methods described herein or are configured to perform steps or subroutines of the methods described herein such that the multiple processors cooperate to achieve the functionality described herein.

FIG. 3 illustrates an exemplary data center with standard service chaining where similar functions are located on the same rack and a local load balancer is used to allocate flows to VMs, configuration 300. Exemplary data center with configuration 300 may contain rack A 305, rack B 310 and rack C 315, multiple load balancers 320, signaling paths 325, virtual machines 330, service data flow content 335, service data chain 337, bearer path service data flow 340, and top of rack switches 345.

Service data flow content 335 may begin processing at or before entering a data center. Service data flow content 335 may have functions of service data chain 337 which are required for a specific packet or data type. For example, a mobile video packet may request processing of Baseband Unit (BBU), Server Gateway (SGW), Border Gateway (BGW) and Content Delivery Network (CDN) functions. The functions of service data chain 337 may be associated with service data flow content 335. For example, these functions may be chained as A, B, C and D, in service data chain 337 respectively as indicated in exemplary data center. Service data flows may refer to multiple data packets associated with the same source and destination addresses as well as data type. Service data flows may further be associated with specific port identifiers specific to the data center and/or rack configurations. When a first packet arrives, an entity such as an SDN controller, for example, may place the notification indicating that A, B, C and D are needed. Port identifications may already be stamped on a packet header.

In an embodiment shown in FIG. 3, one function may be performed on virtual machines 330. One load balancer, such as load balancer 320 may reside on rack A 305 which dispatches data from a service data flow to a VM. In this embodiment, each rack may be capable of performing a single virtualized function and multiple virtual machines may provide the same functionality on each rack. For example, in bearer path service data flow 340, a data packet may be transmitted to one of virtual machines 330 and the virtual machine may communicate with load balancer 320 via signaling path 325. The top of the rack switch (TOR Switch) may next forward the bearer packet to the specific rack for processing of the next function in the service chain. The signaling path 325 may be only directed up and down between one of virtual machines 330, and load balancer 320. A similar implementation may occur on rack B 310 and rack C 315 in order to perform other service chain functions.

Similar processing may occur for a different virtualized function on rack B 310. In one embodiment, rack A 305 may be capable of implementing BBU, rack B 310 may be capable of implementing a SGW and rack 315 may capable of implementing PGW.

FIG. 4 illustrates an exemplary data center involving localized service chaining which utilizes a centralized load balancer configuration 400. Exemplary data center with centralized load balance configuration 400 may contain service data flow content 405, service data chain 407, centralized load balancer 410, rack 1 415, rack 2 420 and rack 3 425, virtual machine A 430, virtual machine B 435, virtual machine C 440, bearer path 445, signaling path 450, and top of rack 1 switch 455.

Exemplary data center with localized service chaining which utilizes a centralized load balancer configuration 400, may reduce inter-rack load by integrating within each rack multiple constituents of a service chain. In some embodiments, a larger number of virtual function instances may be instantiated including one or more on each rack, rack 1 415, rack 2 420 and rack 3 425. Each rack may process any part of a service chain and attempt to keep service data flows within each rack for entire processing. In some embodiments, smaller capacity and/or fewer instances of each function may be instantiated which may consume fewer resources per function. For example, a mobile video packet requesting processing of BBU, SGW, PGW and CDN virtual functions may be able to accomplish all four virtual functions processing on one rack.

A service data flow content 405 may indicate that it requires functions A, B, C and D from service data chain 407. Service data flow content 405 may include several packets of a service data flow associated with service data chain 407. Service data chain 407 may be received directly by the SDN controller when entering exemplary data center, via signaling. The centralized load balancer 410 may maintain a globalized view of the entire data center, including a view of virtual machines on all racks such as rack 1 415, rack 2 420 and rack 3 425.

The centralized load balancer 420 may create a service data flow for service data flow content 405, deciding which virtual machines and/or which rack(s) to utilize for the service data flow based upon the service data chain 407. The centralized load balancer may utilize several policies and/or performance metrics to determine which virtual machines to utilize. The centralized load balancer may then through a SN controller set up the forwarding of packets of the service data flow 405 through the selected set of virtual machines of the service chain.

The service data flow content 405 may follow bearer path 445 upon entering the data center. Simultaneous to following bearer path 445, the virtual machine processing the service data flow content may communicate with centralized load balancer 410 via signaling path 450 to know which virtual machine to go to next. The service data flow may be updated dynamically. For example, once processing is done for function A on virtual machine A 430, the exiting packets may query centralized load balancer 410 to see which virtual machine to go to next. Centralized load balancer may indicate upon this query to go to virtual machine B 435 to perform function B at a specified port. This selection may be used for all subsequent packets of the service chain until the system determines that a path recalculation is appropriate. Such recalculation of the path may be performed periodically or triggered by packet counts, network/VM status changes, or other system metrics.

In some embodiments, a service data flow may receive all its processing steps in the rack it is assigned to. In order to decide which virtual machine performs each function, the infrastructure may query centralized load balancer 410 which may provide the virtual machine identity for the next function in the chain. A small signaling packet, different from packets of the service data flow may be sent to the centralized load balancer 410 by the leading packet of a flow so that packets of the service data flow do not move across racks except for certain instances in which a target such as a least busy virtual machine is located on a separate rack. At each stage of a chain, the infrastructure may provide the ability to direct the packets of the service data flow to the next function in the chain based on the policy provided by the centralized load balancer 410. The policies may be reused for all packets of a service data flow.

Packets in a service data flow may take the same path utilizing one or more virtual machines on the same rack. In some embodiments, the centralized load balancer may look-up and store the subsequent virtual machine in a data structure such as a flow table. A service data flow's sequence of virtual machines may be established and modified within any type of data structure such as a binary tree, a database, a table or a hash table, for example, and stored in software storage 260.

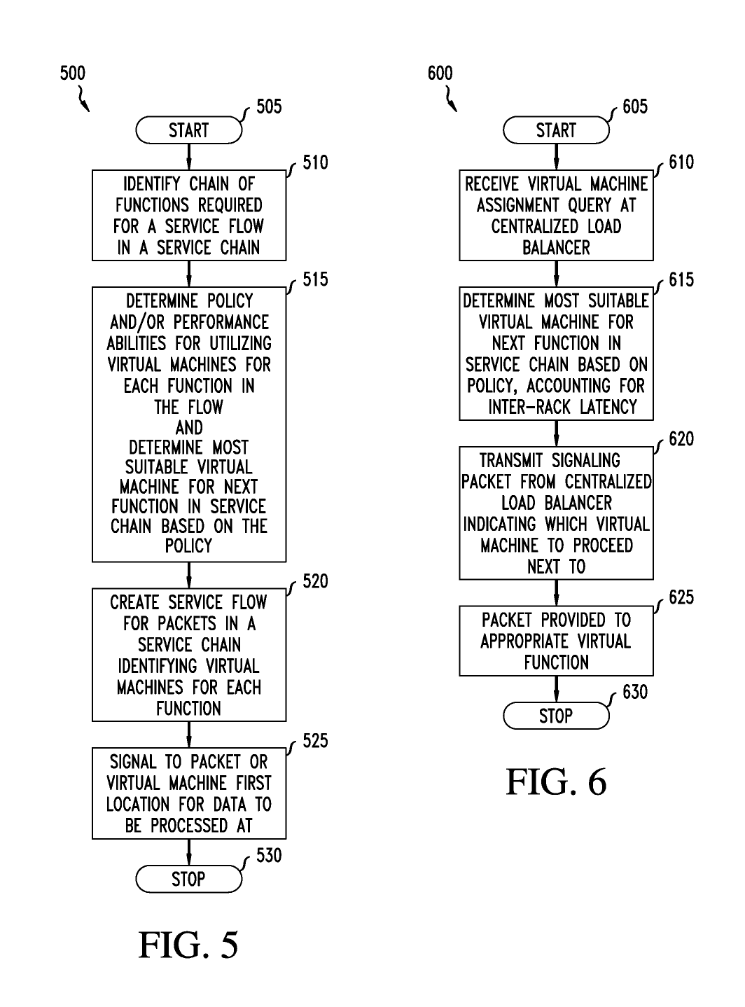

FIG. 5 illustrates an exemplary method for a centralized load balancer initialization process 500. Centralized load balancer 410, for example, may implement exemplary method for a centralized load balancer initialization process 500. Centralized load balancer 410 may begin in step 505 and proceed to step 510 where the centralized load balancer may identify a chain of functions which are required for a service data flow in a service chain. The chain of functions may be provided by a SDN controller. Identification of the chain of functions required may include traversing a path specified by a tag that may be mapped to the chain, or it may be derived from the IP five tuple. Similarly, identification of a chain of functions may include simply identifying a service chain type and looking up locally which functions are required or associated with the service chain. Also, a service chain may be defined explicitly as a part of the service data flow.

Centralized load balancer 410 may proceed to step 515 where centralized load balancer 410 may determine policy and/or performance abilities for utilizing virtual machines for each function in a service data flow. Policy may be dependent on the overall system/data center size, user requirements, system requirements and/or active status of virtual machines and blades available. Load balancer policy and/or performance considerations may prioritize utilizing all or multiple functions on the same rack in order to avoid inter-rack communication and its associated latency and delays. The centralized load balancer 410 may also determine the most suitable virtual machine for the next function in the service chain based on the determined policies or performance abilities. Centralized load balancer 410 may proceed to step 520 where centralized load balancer 410 may create a service data flow for packets in a service chain identifying a virtual machine for each function in the chain. A service data flow may be established within any type of data structure such as a binary tree, a database, a table or a hash table and stored in software storage 260, for example.

In one embodiment a service data flow table may be maintained which can be retrieved at any point such as initialization as well as in querying in method 600. Service data flow table may include hundreds-of thousands of entries for service data flows and their associated service chains that are currently being processed in the data center, have been processed recently, may be processed in the future and/or are otherwise in communication with the data center for any reason.

Centralized load balancer 410 may proceed to step 525 where centralized load balancer 410 may communicate through an SDN controller to an ingress element and/or virtual machine the first location where data should be processed. Signaling to an ingress element associated with a service data flow may occur at a top of rack switch such as top of rack switch 455, or at any other point in the data center infrastructure including any relevant virtual machine.

Centralized load balancer 410 may proceed to step 530 where centralized load balancer 410 may stop operation for that service data flow and/or packet.

FIG. 6 illustrates an exemplary method for centralized load balancing 600. Centralized load balancer 410, for example, may implement exemplary method for centralized load balancing 600. Centralized load balancer 410 may begin in step 605 and proceed to step 610 where the centralized load balancer 410 may receive virtual machine assignment queries. The centralized load balancer may receive queries via signaling path 450, for example. The centralized load balancer may receive queries from leading packets of a service flow through an SDN controller when the leading packet is at any one of the virtual machines or switches. The queries may be received from different racks and/or different functions on the same rack. Centralized load balancer may maintain one occurrence within a data center. Similarly, centralized load balancer may have multiple identical occurrences on different or all racks, and maintain the same data on each. When there is a centralized load balancer on each rack, then the virtual machine or infrastructure of the rack may query the instance of centralized load balancer on the rack where the instance of the virtual machine is occurring.

In some embodiments, a small signaling packet or data type may be sent to the centralized load balancer when querying where to proceed. In some embodiments, assignment queries may occur at a virtual machine, once that virtual machine's function is done processing.

Centralized load balancer 410 may proceed to step 615 where centralized load balancer 410 may determine the most suitable virtual machine for the next function in a service chain. When determining which virtual machine the next function should be performed on in the service data flow, the centralized load balancer may account or base its decision on a policy. The policy may be dependent on the overall system/data center size, user requirements, system requirements and/or active status of virtual machines and blades available. The centralized load balancer may account for inter-rack latency and/or link utilization when determining the next virtual machine. The centralized load balancer may similarly prioritize virtual machines performing the next or other functions in the service chain on the same rack in order to prevent inter-rack latency.

In some embodiments, the centralized load balancer may consider the load on the current virtual machines. In another embodiment, the centralized load balancer may consider the topology of the virtual machines, racks and/or blades. In yet another embodiment, the centralized load balancer may have an accounting algorithm such as a round-robin packet scheduling implemented via efficient hash functions statistical multiplexing, first come first served, weighted round-robin, or a weighted scheduling system. Similarly, the centralized load balancer may simply look up the next already allocated virtual machine in the service data flow and determine the already allocated virtual machine to be the most suitable for performance of the next or subsequent function.

Centralized load balancer 410 may proceed to step 620 where centralized load balancer 410 may transmit a signaling packet from centralized load balancer 410 indicating which virtual machine to proceed to next. The signaling packet may be provided via signaling path 450. The signaling packet or information may include the port number or locator information of the next virtual machine.

In some embodiments, no querying of the centralized load balancer 410 may occur. In some embodiments a virtual machine may have virtual machines already assigned or allocated in a certain period of time. The virtual machines may continue transmitting packets in service data flows for a time period allocated by the centralized load balancer. In some embodiments, virtual machines continue transmission autonomously until centralized load balancer 410 may send a signaling packet indicating otherwise.

In step 625 the packet may be provided to the appropriate virtual function. Similarly, the virtual machine which has finished performing its operations may transmit the packet along with all the packets in the service data flow to the port and virtual machine which was indicated by the centralized load balancer.

Centralized load balancer 410 may proceed to step 630 where centralized load balancer 410 may cease operation dealing with that service data flow.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of balancing a load of inter-virtual machine traffic in a data center including a plurality of racks at a centralized load balancer comprising:
receiving at the centralized load balancer, a path inquiry for a data packet;
determining which virtual machine to assign the data packet to,
wherein at least two functions of the services needed in the data packet's service data flow are to be performed on the same rack; and
assigning the data packet to the determined virtual machines.

2. The method of claim 1, wherein the determining further comprises:
utilizing policy information to determine which virtual machines will process the service data flow.

3. The method of claim 1, wherein the determining further comprises:
utilizing current virtual machine capability to determine which virtual machines will process the service data flow.

4. The method of claim 1, wherein the determining further comprises:
utilizing current network status information to determine which virtual machines will process the service data flow.

5. The method of claim 1, wherein an identical centralized load balancer is instantiated on two racks in the data center.

6. The method of claim 1, wherein the determining further comprises:
utilizing a round robin assignment algorithm to determine which virtual machines will process the service data flow.

7. The method of claim 1, further comprising:
updating which virtual machine will perform at least one of the functions of the chain of functions.

8. A non-transitory machine-readable storage medium encoded with instructions for execution by a centralized load balancer for balancing a load of inter-virtual machine traffic in a data center including a plurality of racks, the medium comprising:
instructions for receiving at the centralized load balancer, a path inquiry for a data packet;
instructions for determining which virtual machine to assign the data packet to,
wherein at least two functions of the services needed in the data packet's service data flow are to be performed on the same rack; and
instructions for assigning the data packet to the determined virtual machines.

9. The non-transitory machine-readable storage medium of claim 8, wherein the instructions for determining further comprises:
instructions for utilizing policy information to determine which virtual machines will process the service data flow.

10. The non-transitory machine-readable storage medium of claim 8, wherein the instructions for determining further comprises:
instructions for utilizing current virtual machine capability information to determine which virtual machines will process the service data flow.

11. The non-transitory machine-readable storage medium of claim 8, wherein an identical centralized load balancer is instantiated on two racks in the data center.

12. The non-transitory machine-readable storage medium of claim 8, wherein the instructions for determining further comprises:
instructions for utilizing a round robin assignment algorithm to determine which virtual machines will process the service data flow.

13. The non-transitory machine-readable storage medium of claim 8, further comprising:
instructions for updating which virtual machine will perform at least one of the functions of the chain of functions.

14. A centralized load balancer for balancing a load of inter-virtual machine traffic in a data center including a plurality of racks comprising:
a memory configured to store a service data flow table;
a processor configured to:
receive at the centralized load balancer, a path inquiry for a data packet;
determine which virtual machine to assign the data packet to
wherein at least two functions of the services needed in the data packet′ service data flow are to be performed on the same rack; and
assign the data packet to the determined virtual machines.

15. The centralized load balancer of claim 14, wherein the processor is further configured to:
utilize policy information to determine which virtual machines will process the service data flow.

16. The centralized load balancer of claim 14, wherein the processor is further configured to:
utilize current virtual machine capability information to determine which virtual machine to provide the service data flow to.

17. The centralized load balancer of claim 14, wherein the processor is further configured to:
utilize current network status information to determine which virtual machine to provide the service data flow to.

18. The centralized load balancer of claim 14, wherein an identical centralized load balancer is instantiated on two racks in the data center.

19. The centralized load balancer of claim 14, wherein the processor is further configured to:
utilize a round robin assignment algorithm to determine which virtual machines will process the service data flow.

20. The centralized load balancer of claim 14, wherein the processor is further configured to:
update which virtual machine will perform at least one of the functions of the chain of functions.
